(19) United States
(12) Patent Application Publication
(10) Pub. No.: US 2011/0180221 A1
(43) Pub. Date: Jul. 28, 2011

(54) WINDOW BLIND ASSEMBLY

(76) Inventor: Jieh-Ren Huang, Kaohsiung (TW)

(21) Appl. No.: 12/823,071

(22) Filed: Jun. 24, 2010

Related U.S. Application Data
(63) Continuation-in-part of application No. 12/692,019, filed on Jan. 22, 2010.

(51) Int. Cl. A47H 5/02; E06B 9/24

(52) U.S. Cl. 160/344

(57) ABSTRACT

A window blind assembly includes a window blind unit, a protection unit, and a control unit. The window blind unit includes a mounting seat and a shading member that has a front surface and a rear surface. The protection unit includes a protection cord that is connected to the window blind unit, and a plurality of support rings connected to the protection cord. Select ones of the support rings are connected also to the rear surface of the shading member. The control unit includes a driver that is mounted to the mounting seat, and a cord that has a connecting segment and an extending segment. The connecting segment extends through the driver and the shading member, passes through the support rings, and is connected to the shading member of the window blind unit at a bottom end thereof. The extending segment is opposite to the connecting segment.

### CROSS-REFERENCE TO RELATED APPLICATION

This application is a continuation-in-part of U.S. patent application Ser. No. 12/692,019, filed by the applicant on Jan. 22, 2010, the entire disclosure of which incorporated herein by reference.

### BACKGROUND OF THE INVENTION

1. Field of the Invention

The present invention relates to a window blind assembly, more particularly to a window blind assembly for enhanced safety.

2. Description of the Related Art

Referring to FIG. 1, a conventional window blind assembly includes a mounting seat 11, a shading member 12 that is mounted to the mounting seat 11 and that extends downwardly, a driver 13 that is mounted to the mounting seat 11, a plurality of guide rings 14 that are connected to the shading member 12 and that are spaced apart vertically from each other, and cords 15 each of which is disposed on the shading member 12 and extends through the driver 13 and passes through the guide rings 14.

Typically, when the shading member 12 extends downwardly, a vertical spacing between two adjacent ones of the guide rings 14 connected to the shading member 12 is about twelve inches. As a result, if a child sticks his/her head between any one of the cords 15 and the shading member 12, it is possible for the cord 15 to wrap around the child's neck, thereby causing strangling injury. Furthermore, as shown in FIG. 2, a cord loop 151 is formed easily when the shading member 12 is folded and a child pulls one of the cords 15 disposed on the shading member 12. This also may cause strangling injury or accidents.

According to statistics, strangling injury or other accidents involving window curtains occur every month in the US. Therefore, it is necessary to focus on this issue.

### SUMMARY OF THE INVENTION

Therefore, the object of the present invention is to provide a safe window blind assembly.

Accordingly, a window blind assembly of the present invention comprises a window blind unit, a protection unit, and a control unit.

The window blind unit includes amounting seat, and a shading member that is mounted to the mounting seat and that extends downwardly therefrom. The shading member has a front surface and a rear surface.

The protection unit includes a protection cord that is connected to the window blind unit, and a plurality of support rings connected to the protection cord and spaced apart vertically from each other. Select ones of the support rings are connected also to the rear surface of the shading member.

The control unit includes a driver that is mounted to the mounting seat, and a cord that has a connecting segment and an extending segment. The connecting segment extends through the driver and the shading member, passes through the support rings such that the connecting segment is interposed between the rear surface of the shading member and the protection cord, and is connected to the shading member of the window blind unit at a bottom end thereof. The extending segment is opposite to the connecting segment, and extends downwardly from the driver.

The shading member is moveable between a fully unfolded position and a fully folded position by manipulation of the extending segment of the cord and by cooperation of the cord with the driver.

When the extending segment is pulled to fold the shading member, the protection cord is also folded.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional window blind assembly;

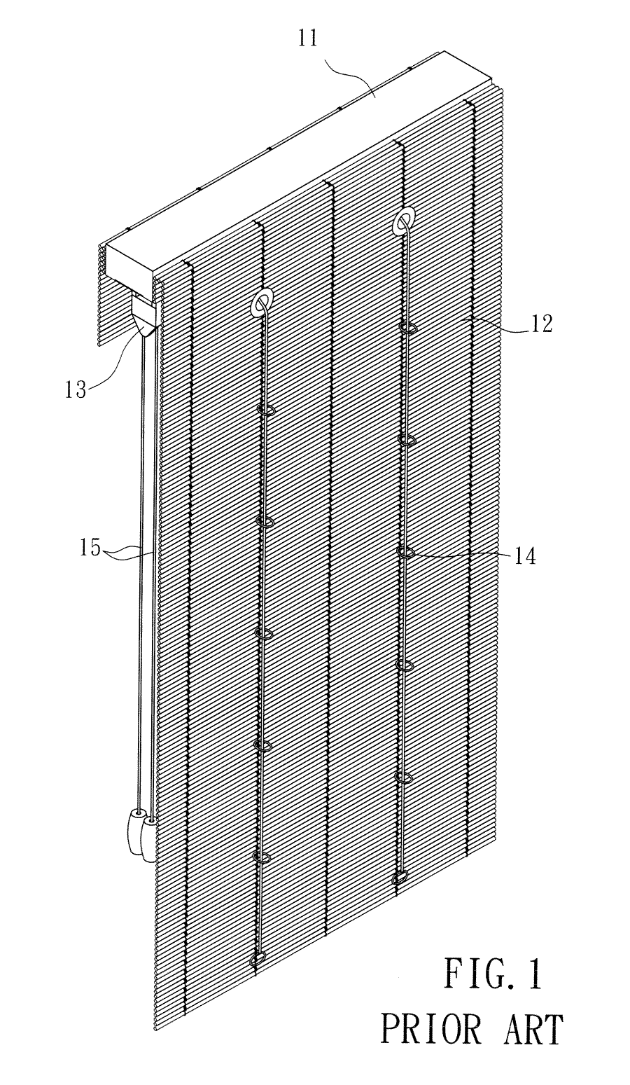

FIG. 2 is a fragmentary side view of the conventional window blind assembly, illustrating how a cord loop is formed while a shading member in a folded position;

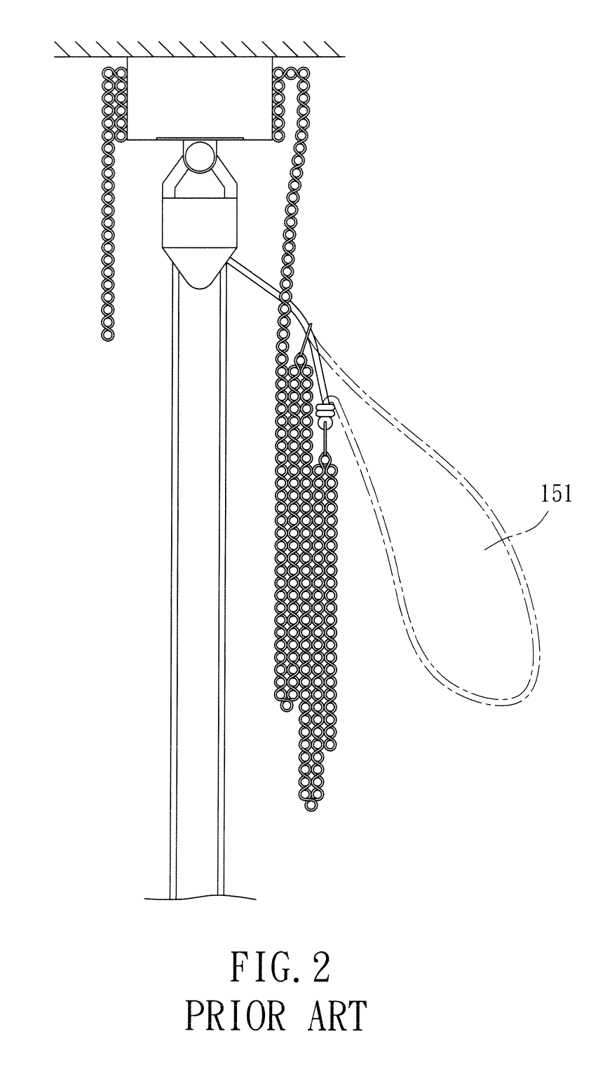

FIG. 3 is a perspective view of a window blind assembly according to a first preferred embodiment of the present invention;

FIG. 4 is a side view of the window blind assembly according to the first preferred embodiment of the present invention, illustrating a shading member in an unfolded position;

FIG. 5 is a side view of the window blind assembly according to the first preferred embodiment of the present invention, illustrating the shading member in a partially folded position;

FIG. 6 is a perspective view of a window blind assembly according to a second preferred embodiment of the present invention;

FIG. 7 is a side view of the window blind assembly according to the second preferred embodiment of the present invention, illustrating the shading member in an unfolded position;

FIG. 8 is a side view of the window blind assembly according to the second preferred embodiment of the present invention, illustrating the shading member in a partially folded position;

FIG. 9 is a perspective view of a window blind assembly according to a third preferred embodiment of the present invention; and

FIG. 10 is a perspective view of a window blind assembly according to a fourth preferred embodiment of the present invention.

### DETAILED DESCRIPTION OF THE PREFERRED EMBODIMENTS

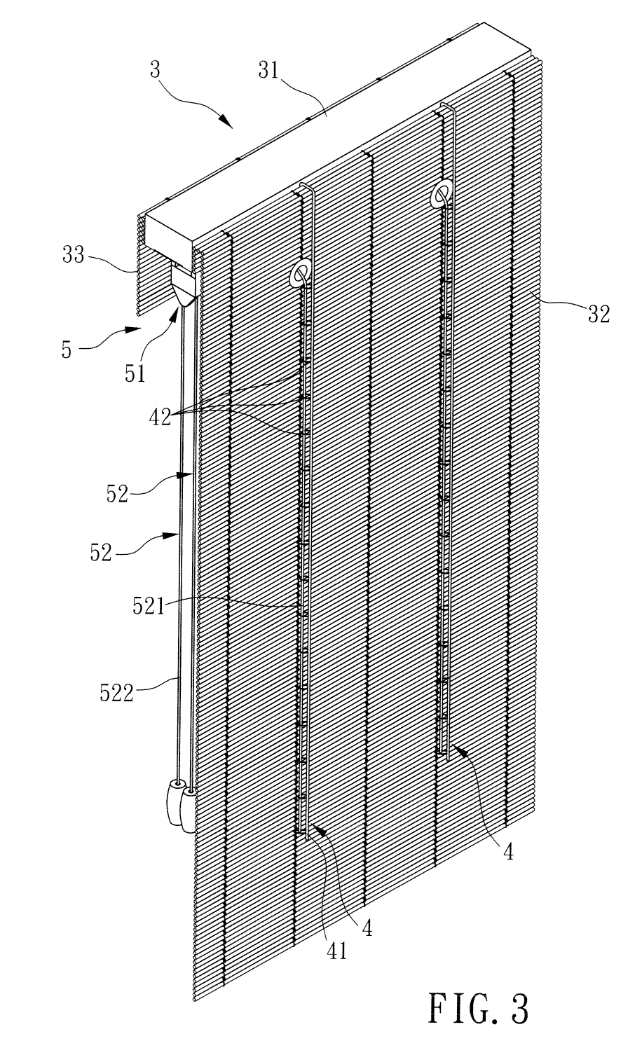

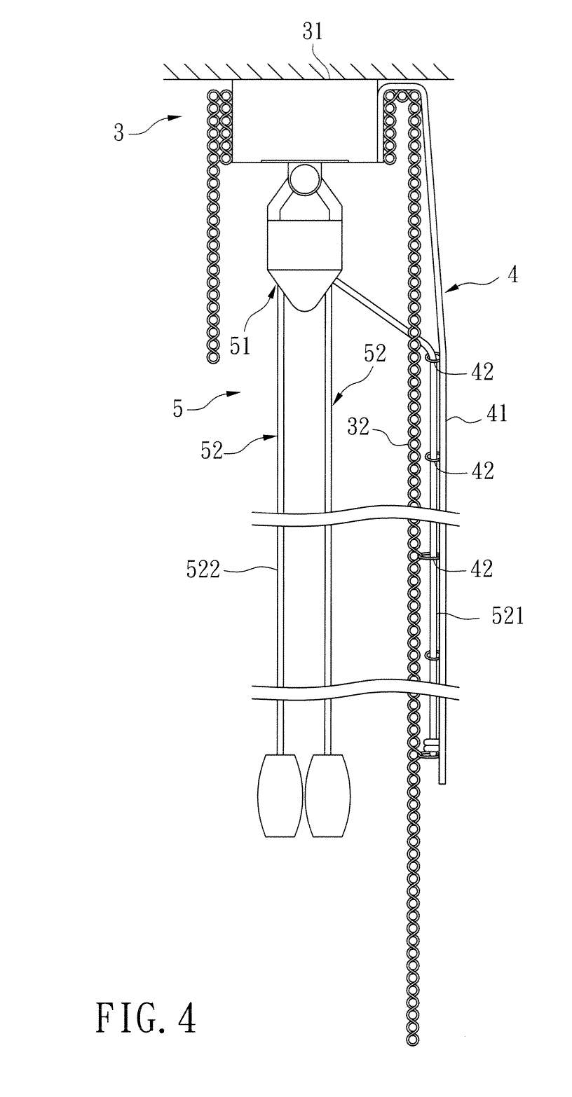

Referring FIGS. 3 and 4, a first preferred embodiment of a window blind assembly according to the present invention is shown to comprise a window blind unit 3, two protection units 4, and a control unit 5. The quantity of protection units 4 is dependent upon the width of the window blind unit 3.

The window blind unit 3 includes amounting seat 31, a shading member 32, and a cover piece 33. The shading member 32 is mounted to a rear side of the mounting seat 31, and extends downwardly therefrom. The shading member 32 has a front surface and a rear surface. The cover piece 33 is mounted to a front side of the mounting seat 31.

In this embodiment, the shading member 32 is constructed by weaving bamboo pieces to form a roman curtain. However, any other materials and/or fabrics and/or interconnecting methods for roman curtain configurations may be used. Furthermore, the cover piece 33 is used for improving the aesthetics of the window blind assembly of the present invention, and is optional.

Each of the protection units 4 includes a protection cord 41, and a plurality of support rings 42. The support rings 42 are connected to the protection cord 41, and are spaced apart vertically from each other. Select ones of the support rings 42 are connected also to the rear surface of the shading member 32. An upper end of the cord 41 is connected to one of the mounting seat 31 of the window blind unit 3 and a top portion of the shading member 32 of the window blind unit 3. A lower end of the cord 41 is connected to a lower portion of the shading member 32 of the window blind unit 3. In this embodiment, the lower end of the cord 41 is connected to the lower portion of the shading member 32 of the window blind unit 3 through the lowermost support ring 42.

In this embodiment, a vertical spacing between two adjacent ones of the support rings 42 is less than two inches, and each of the support rings 42 has a diameter that is less than two centimeters. Moreover, a vertical spacing between two adjacent ones of the select ones of the support rings 42 connected to the shading member 32 is less than eight inches. However, the connecting configuration of and spacing between the support rings 42 are not limited in this regard, and may be varied as needed.

In other embodiments, the vertical spacing between each adjacent pair of the support rings 42 connected to both the shading member 32 and the protection cord 41 is less than eight inches, and one of the support rings 42 connected only to the protection cord 41 is disposed between each adjacent pair of the support rings 42 connected to both the shading member 32 and the protection cord 41. In some embodiments, the one of the support rings 42 connected only to the protection cord 41 is disposed approximately at a middle point between each adjacent pair of the support rings 42 connected to the shading member 32.

The control unit includes a driver 51 and two cords 52. The driver 51 is mounted to bottom side of the mounting seat 31, and is concealed by the cover piece 33. Each of the cords 52 has a connecting segment 521 and an extending segment 522.

The connecting segment 521 extends through the driver 51 and the shading member 32, passes through the support rings 42 of the corresponding protection unit 4 such that the connecting segment 521 is interposed between the rear surface of the shading member 32 and the protection cord 41 of the corresponding protection unit 4, and is connected to the shading member 32 of the window blind unit 3 at a bottom end thereof. The extending segment 522 is opposite to the connecting segment 521, and extends downwardly from the driver 51. The bottom end of the connecting segment 521 of the cord 52 is connected to the shading member 32 through one of the select ones of the support rings 42 connected also to the rear surface of the shading member 32.

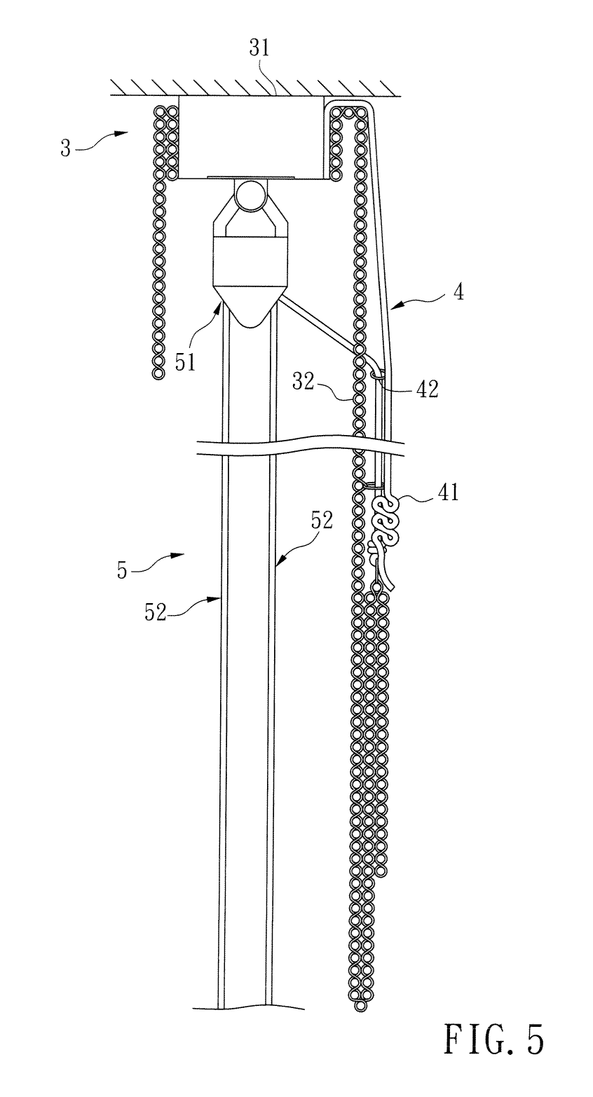

The shading member 32 is moveable between a fully unfolded position and a fully folded position by manipulation of the extending segment 522 of the cord 52 and by cooperation of the cord 52 with the driver 51. With reference to FIG. 5, when the extending segment 522 is pulled to fold the shading member 32, the protection cord 41 is also folded. The driver 51 is able to control and lock the cord 52 so as to fix the shading member 32 at a particular position.

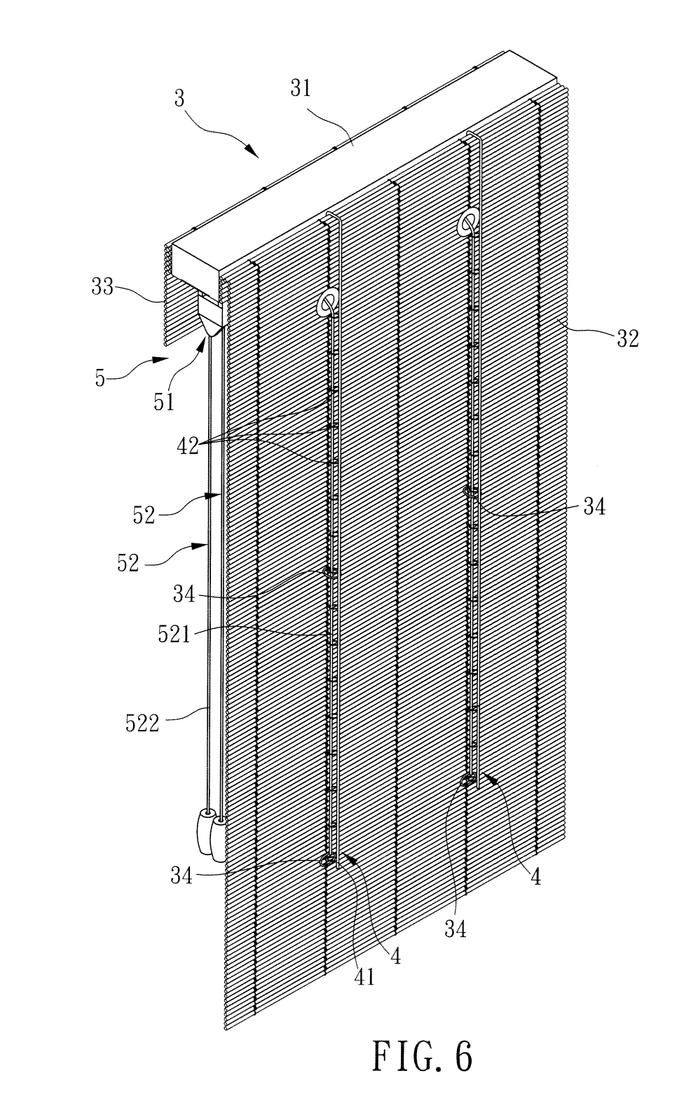

FIGS. 6, 7, and 8 illustrate a second preferred embodiment of the window blind assembly according to the present invention. The second preferred embodiment differs from the first preferred embodiment in the following aspects.

The window blind unit 3 further includes a plurality of fixing rings 34 that are connected to the shading member 32. The select ones of the support rings 42 are connected to the rear surface of the shading member 32 through the fixing rings 34.

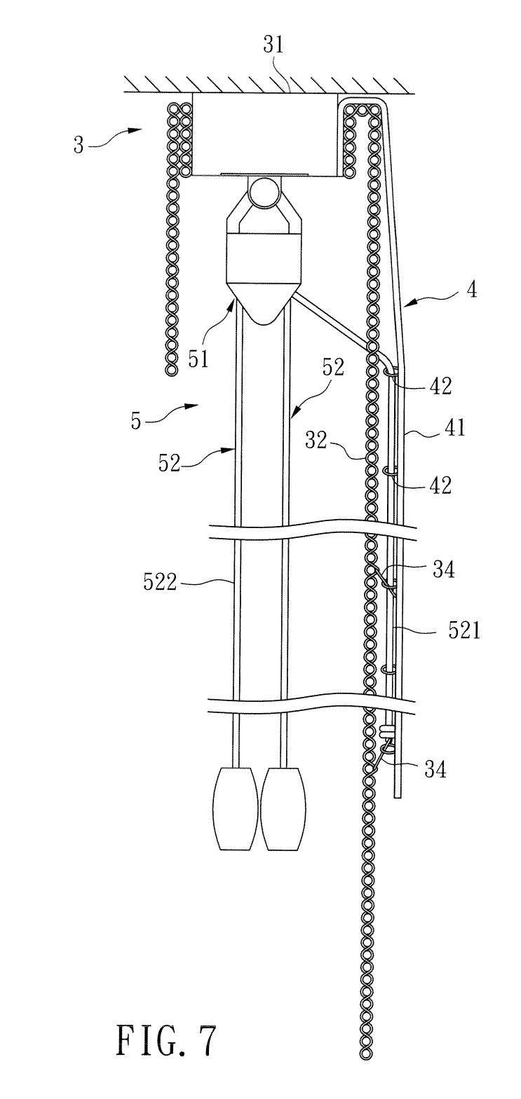

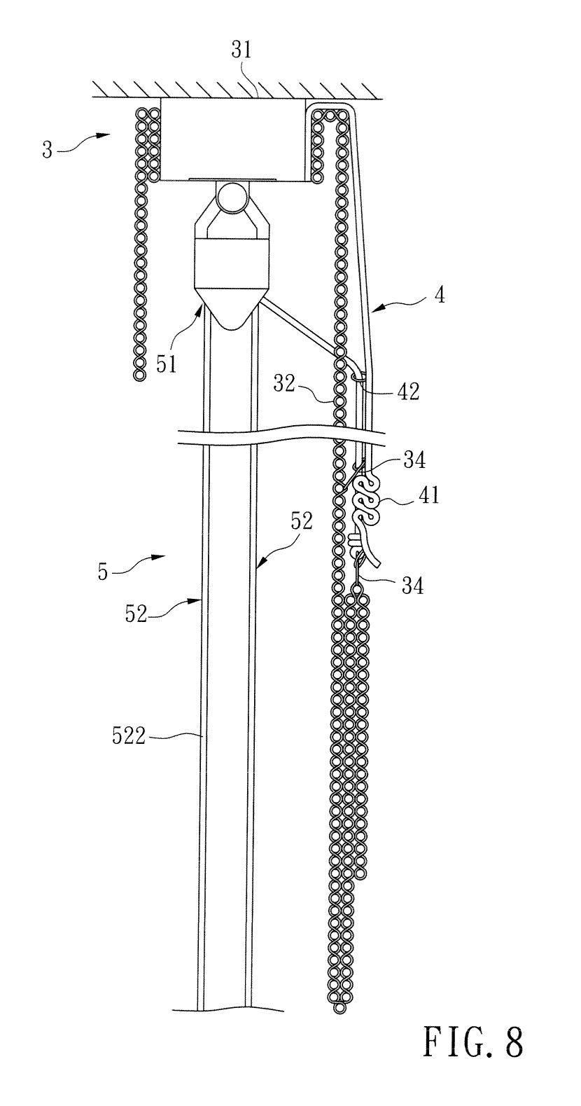

FIGS. 7 and 8 illustrate an operation principle of the second preferred embodiment of the present invention. By pulling the cords 52, the fixing rings 34 are able to fold up the shading member 32.

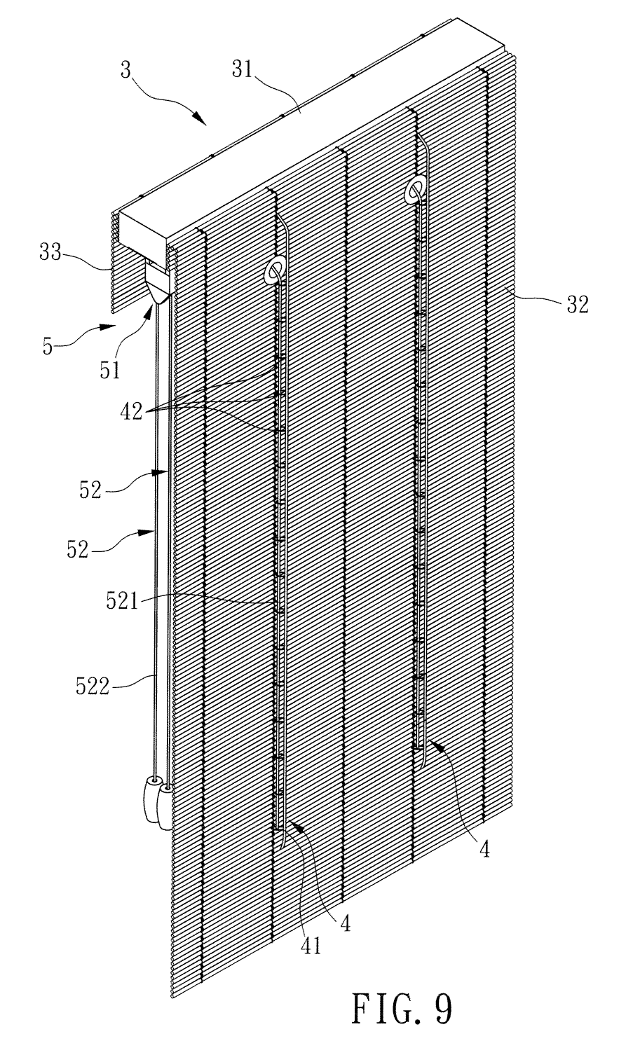

FIG. 9 illustrates a third preferred embodiment of the window blind assembly according to the present invention. The third preferred embodiment differs from the first preferred embodiment in the following aspects.

The upper end of each of the protection cords 41 is sewed on the upper portion of the shading member 32 of the window blind unit 3.

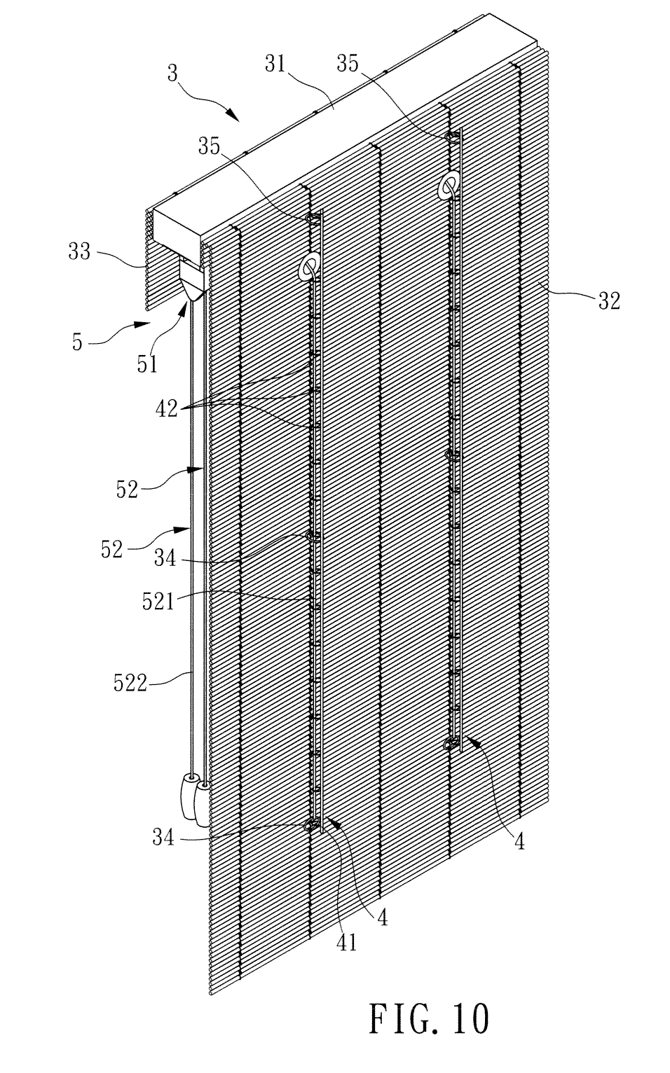

FIG. 10 illustrates a fourth preferred embodiment of the window blind assembly according to the present invention. The fourth preferred embodiment differs from the second preferred embodiment in the following aspects.

The window blind unit 3 further includes a plurality of fixing rings 34 connected to the shading member 32, and an anchoring ring 35 connected to the shading member 32. The select ones of the support rings 42 of each of the protection units 4 are connected to the rear surface of the shading member 32 through the fixing rings 34. The upper end of each of the cords 41 is connected to the shading member 32 through the anchoring ring 35.

In some embodiments, the upper end of each of the cords 41 may be connected to a particular fixing ring 34.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A window blind assembly comprising:
a window blind unit including a mounting seat, and a shading member that is mounted to said mounting seat and that extends downwardly therefrom, said shading member having a front surface and a rear surface;
a protection unit including a protection cord that is connected to said window blind unit, and a plurality of support rings connected to said protection cord and spaced apart vertically from each other, select ones of said support rings being connected also to said rear surface of said shading member; and
a control unit including a driver that is mounted to said mounting seat, and a cord having a connecting segment that extends through said driver and said shading member, passes through said support rings such that said connecting segment is interposed between said rear surface of said shading member and said protection cord, and is connected to said shading member of said window blind unit at a bottom end thereof, and an extending segment opposite to said connecting segment and extending downwardly from said driver;
wherein said shading member is moveable between a fully unfolded position and a fully folded position by manipulation of said extending segment of said cord and by cooperation of said cord with said driver; and
wherein when said extending segment is pulled to fold said shading member, said protection cord is also folded.

2. The window blind assembly as claimed in claim 1, wherein a vertical spacing between two adjacent ones of said select ones of said support rings connected to said shading member is less than eight inches.

3. The window blind assembly as claimed in claim 1, wherein said window blind unit further includes a plurality of fixing rings that are connected to said shading member, said select ones of said support rings being connected to said rear surface of said shading member through said fixing rings, an upper end of said cord being connected to said mounting seat of said window blind unit.

4. The window blind assembly as claimed in claim 3, wherein a vertical spacing between two adjacent ones of said fixing rings is less than eight inches.

5. The window blind assembly as claimed in claim 1, wherein said window blind unit further includes a plurality of fixing rings connected to said shading member, and an anchoring ring connected to said shading member, said select ones of said support rings being connected to said rear surface of said shading member through said fixing rings, an upper end of said cord being connected to said shading member through said anchoring ring.

6. The window blind assembly as claimed in claim 1, wherein a vertical spacing between two adjacent ones of said support rings is less than two inches.

7. The window blind assembly as claimed in claim 6, wherein each of said support rings has a diameter that is less than two centimeters.

8. The window blind assembly as claimed in claim 1, wherein said shading member is mounted to a rear side of said mounting seat and said driver is mounted to a bottom side of said mounting seat, said window blind unit further including a cover piece that is mounted to a front side of said mounting seat so as to conceal said driver.

9. The window blind assembly as claimed in claim 1, wherein a vertical spacing between each adjacent pair of said support rings connected to both said shading member and said protection cord is less than eight inches, and one of said support rings connected only to said protection cord is disposed between each adjacent pair of said support rings connected to both said shading member and said protection cord.

10. The window blind assembly as claimed in claim 9, wherein said one of said support rings connected only to said protection cord is disposed approximately at a middle point between each adjacent pair of said support rings connected to said shading member.

11. The window blind assembly as claimed in claim 1, wherein an upper end of said cord is connected to one of said mounting seat of said window blind unit and said shading member of said window blind unit.

12. The window blind assembly as claimed in claim 1, wherein said bottom end of said connecting segment of said cord is connected to said shading member through one of said select ones of said support rings connected also to said rear surface of said shading member.
